(19) United States
(12) Patent Application Publication
(10) Pub. No.: US 2021/0004211 A1
(43) Pub. Date: Jan. 7, 2021

(54) SYSTEM AND METHOD FOR USER CREATED OBJECT, PROPERTY, METHOD, OR EVENT WITH PHYSICAL MANIPULATIVES

(71) Applicant: Zheng Shi, Beijing (CN)

(72) Inventor: Zheng Shi, Beijing (CN)

(21) Appl. No.: 16/857,367

(22) Filed: Apr. 24, 2020

Related U.S. Application Data
(63) Continuation-in-part of application No. PCT/CN2018/104492, filed on Sep. 7, 2018.

(51) Int. Cl. G06F 8/34; G06F 3/0481; G09B 19/00

(52) U.S. Cl. CPC G06F 8/34; G06F 3/0482; G09B 19/0053; G06F 3/04817

(57) ABSTRACT

The present invention provides system and method for creating a User Program using multiple physical manipulatives, one or more user interfaces, and an interactive board that can read the unique ID of the physical manipulatives placed upon it. A programming user creates the User Program by defining programming elements such as Objects, Properties, Methods, and Events, and by creating a programming structure utilizing those programming elements, all implemented with physical manipulatives.

### CROSS-REFERENCE TO RELATED APPLICATION

This application is a continuation in part of International Patent Application No. PCT/CN2018/104492, entitled “System and Method for User Created Object, Property, Method, or Event with Physical Manipulatives”, filed on Sep. 7, 2018. The entire disclosure of the above application is incorporated herein by reference.

### TECHNICAL FIELD

The present invention relates to a system and method for programmers to create computer programs using physical manipulatives.

### BACKGROUND

Class, Object, Properties, Methods, and Events; this is a basic set of programming concepts utilized by many programming languages. In efforts to make programming accessible to programmers of ever younger age, many tangible programming systems and methods have been developed to teach programming concepts such as sequences, conditions and loops. Some systems allow children to build a computer program with physical manipulatives to direct a robot that moves on a screen. Others allow an on-screen programming of a physically movable object, such as a ball, a toy car, or a toy robot.

We define the following three roles for the purpose of clarity: vendor, who has developed a tangible programming system and/or method; programming user, who utilizes such system and/or method to create a computer program; operating users, who operates the program created by the programming user.

In situations where the primary purpose of the tangible programming system and/or method is to teach programming, the programming user role and the operating user role tend to be of one and the same.

In the case of physical manipulatives as building blocks for programming an on-screen object (e.g., a monster or a robot), the vendor provides the physical manipulatives, each with a specific definition in the context of programming. Further, the vendor provides technical means such that the structure built by the programming user with the physical manipulatives can be recognized by the vendor's programming system and/or method.

In the case of physically movable objects that express the execution of an on-screen program, the vendor provides the programming user with a set of Class, Object, Properties, Methods, and Events that the programming user utilizes to create the on-screen computer program. Such on-screen program is then deployed to operate the physically movable objects.

In our own invention U.S. Pat. No. 9,268,535 B2, we described a system and method for creating a program by building a logic structure with physical objects on an interactive board that recognizes the physical objects and the logic structure.

Given all that has been invented and/or developed, we believe that the current inventions and developments of tangible programming are still rather limited and restrictive, and that there is still a need to deliver the full power of programming into the hands of early programmers such as young children, such that they can freely create objects, build stories and express causality of events based on their imagination, with the programming and execution of the program accomplished exclusively with physical manipulatives that are natural and intuitive for programmers of young age.

In summary, when it comes to teaching the concepts of coding, there is a need to create a system and method that enables to break restrictions by vendor specifications and empower free-form creation with physical manipulatives.

### SUMMARY OF THE INVENTION

In accordance with one embodiment of the present invention, once the capacitive sensor has detected the object with the electrically poorly conductive material, a first capacitive coupling value is generated and transmitted to the processor. And once an external object is in contact with the object while the object remains stationary, the capacitive sensor senses the external object through the electrically poorly conductive material, and a second capacitive coupling value is generated and transmitted to the processor. If the second capacitive coupling value is greater than the first capacitive coupling value, the processor derives that an external object has been in contact with the object. If the second capacitive coupling value is equal to the first capacitive coupling value, the processor is derives that no external object has been in contact with the object.

The present invention resolves the issues highlighted in the prior art by providing a system and method to program code using physical manipulatives. Such a design provides a number of benefits such as: freedom and flexibility in expressing and programming the imagination of programmers, especially children; creating User Programming Elements not provided by a vendor; incorporating User Content Elements not provided by a vendor; creating user interface on physical sheets that serves as functional user interface for a User Program; and finally, the usage of physical cards and RFID tags currently enabling the cheapest materials with most versatile implementation.

In accordance with one embodiment of the present invention, a system and method is disclosed for creating an Object, and for creating Property, Method and Events for the Object, for the purpose of creating a computer executable program, utilizing physical manipulatives embedded with machine-readable and unique identifications.

In accordance with one embodiment of the present invention, the system includes an interactive board capable of reading and locating physical manipulative with RFID tags embedded into them, a programming physical sheet and blank cards with each having RFID tags embedded into them. The programming physical sheet is further marked with multiple icons, with each icon representing a programming element. Once a programming user places the programming physical sheet on the interactive board and instructs the interactive board to start a new Template Program, the programming user creates a programming card, by placing a blank card on a desired programming element of the physical programming sheet and instructing the interactive board to associate the unique ID (UID) of the blank card with this specific User Programming Element. The interactive board is configured to incorporate the User Programming Element into a User Program, by generating executable program code using the programming element associated to the blank card(s) (a.k.a programming card), and by inserting such executable program code into the Template Program to create the User Program, or into an existing User Program to modify the existing User Program, once the programming user places the programming card in an array of other programming cards on the programming physical sheet.

In accordance with one embodiment of the present invention, a programming element might be Object, Property, Method, or Event. In accordance with another embodiment of the present invention, a programming element may also be controls, operators and comparators.

In accordance with another embodiment of the present invention, the system includes multiple cards, each embedded with a UID, a programming physical sheet embedded with a UID and marked with multiple icons, each icon representing a User Programming Element. The User Programming Element could be Object, Property, Method, or Event. The system further includes an interactive board that reads the UID of a card or a physical sheet, once the card or the physical sheet is placed on the interactive board. The programming user places the programming physical sheet on the interactive board and instructs the interactive board to start a new Template Program, and creates a first user programming card by placing a first card on the programming physical sheet, by selecting a first User Programming Element, and by instructing the interactive board to associate the UID of the first card with the first User Programming Element. Further, the interactive board is configured to incorporate the User Programming Element into a User Program, by generating executable program code using the first User Programming Element, and by inserting such executable program code into the Template Program to create the User Program, once the programming user places the first user programming card in an array of other programming cards on the programming physical sheet to create a programming structure. The executable program code can also be inserted into an existing User Program to modify the existing User Program.

In accordance with another embodiment of the present invention, the system further includes system programming cards, and the programming user creates the system programming card by instructing the interactive board to associate the UID of a card with a System Programming Element that might be control, operator, or comparator. Further, the interactive board is configured to incorporate the System Programming Element into the User Program, once the programming user places the system programming card in an array of other programming cards on the programming physical sheet to create a programming structure.

In accordance with another embodiment of the present invention, the system further includes System Services, and a System Service is provided by a device that could be light, sound, capacitance sensor, RFID reader, microphone, or speaker. Further, such device is operatively linked to the interactive board, and the interactive board is configured to enable the programming user to call upon a System Service using a programming card.

In accordance with another embodiment of the present invention, the system further includes user content cards, and the programming user creates a user content card by instructing the interactive board to associate the UID of a card with a User Content Element. Further, the User Content Element is provided by the programming user and the interactive board is configured to enable the programming user to incorporate the User Content Element into the user program.

In accordance with another embodiment of the present invention, the system further includes application cards, and the programming user instructs the interactive board to associate the User Program with the application card. Further, the interactive board is configured to launch the User Program once the application card is placed on the interactive board.

In accordance with another embodiment of the present invention, the system further includes an operating physical sheet marked with the user interface of the User Program. An operating user operates the User Program once the application card is placed on the operating physical sheet.

In accordance with another embodiment of the present invention, the programming user modifies a card to create a visual indication of the programming element having been or to be associated with the card.

In accordance with another embodiment of the present invention, a system for incorporating a User Content Element into a User Program includes a card embedded with a UID, a User Content Element provided by a programming user, an interactive board that recognizes the UID of a card. In the system, the programming user creates a user content card by instructing the interactive board to associate the UID of the card with the User Content Element, and the interactive board is configured to incorporate the User Content Element into a User Program once the programming user places the user content card on the interactive board.

In accordance with another embodiment of the present invention, a system for creating a user programming card includes multiple cards, each embedded with a UID, multiple User Programming Elements that might be Object, Property, Method, or Event, and an interactive board that reads the UID of a card once the card is placed on the interactive board. A programming user creates a first user programming card, by instructing the interactive board to associate the UID of a first card selected by the programming user with a first User Programming Element selected by the programming user. Further, the interactive board is configured to generate executable program code using the first User Programming Element, once the programming user places the first user programming card on the interactive board.

In accordance with another embodiment of the present invention, a system is disclosed for creating the user interface of a User Program with user interface cards. The system includes multiple user interface cards, each embedded with a UID and each associated with a User Interface Element, an operating physical sheet embedded with a UID, and an interactive board that reads the UID of the card or the operating physical sheet once the card or the operating physical sheet is placed on the interactive board. A programming user places a first user interface card on the operating physical sheet and draws an icon of the first User Interface Element on the operating physical sheet, and the interactive board is configured to associate the icon with the first User Interface Element, and to incorporate the first User Interface Element into a User Program.

In accordance with other embodiments of the present invention, the interactive board and the physical sheet described in the preceding paragraphs are implemented as a touch screen device, whereby, each physical sheet is replaced by a touch-based user interface implemented on the touch screen. In accordance with these other embodiments of the present invention, there is no need for a UID for the physical sheets, and the action of placing a physical sheet on an interactive board is replaced with starting a user interface on a screen of the interactive board.

### BRIEF DESCRIPTION OF THE DRAWINGS

To better illustrate the technical features of the embodiments of the present invention, various embodiments of the present invention will be briefly described in conjunction with the accompanying drawings. It should be obvious that the drawings are for exemplary embodiments of the present invention, and that a person of ordinary skill in the art may derive additional drawings without deviating from the principles of the present invention.

FIG. 1 is an exemplary schematic diagram illustrating a system for creating a User Program with programming cards using an interactive board, a programming physical sheet or a programming user interface, and multiple cards in accordance with one embodiment of the present invention.

FIGS. 2a and 2b are exemplary schematic diagrams illustrating the utilization of programming cards in a story-telling game that utilizes forest animals as a theme for a programming user to develop an interactive storyline in accordance with one embodiment of the present invention.

FIGS. 3a, 3b and 3c are exemplary schematic diagrams illustrating the programming user making use of programming cards upon a second programming physical sheet to modify a Template Program in accordance with one embodiment of the present invention.

FIG. 4a and FIG. 4b are exemplary schematic diagrams illustrating the process flow in accordance with embodiments of the present invention.

FIG. 5 is an exemplary schematic diagram illustrating a blank card being associated with a programming user's recorded audio content in accordance with one embodiment of the present invention.

FIGS. 6a and 6b are exemplary schematic diagrams illustrating the use of application cards in accordance with one embodiment of the present invention.

FIG. 7 is an exemplary schematic diagram illustrating the programming user creating a user interface card in accordance with one embodiment of the present invention.

FIG. 8 is an exemplary schematic diagram illustrating the utilization of user interface cards to assign User Interface Elements on a blank operating physical sheet in accordance with one embodiment of the present invention.

FIGS. 9a, 9b, 9c, 9d, and 9e are exemplary schematic diagrams illustrating the combination of multiple programming physical sheets, an operating physical sheet, and multiple cards and figurines upon an interactive board in order to create a story narration and action game in accordance with one embodiment of the present invention.

### DETAILED DESCRIPTION OF THE INVENTION

Reference will now be made in detail to various embodiments of the invention, examples of which are illustrated in the accompanying drawings. While the invention will be described in conjunction with these embodiments, it will be understood that this is not intended to limit the scope of the invention to these specific embodiments. Well known methods, procedures, components, and circuits are not described in detail to avoid unnecessarily obscuring a clear understanding of the present invention. The invention is intended to cover all alternatives, modifications and equivalents within the spirit and scope of invention, which is defined by the apprehended claims.

Furthermore, although the term “program” has been extensively used to represent what a user of the system or method of the present invention may create, modify or execute, this program should not be confused with an application that runs on a conventional computer such as a PC, a Mac, a smart tablet, or a smart phone. One of the distinctions is that, as a user engages in activities described by the embodiments or the system or the method of this present invention, the user does not need to interact with an electronic display screen, although an electronic screen may be utilized as an embodiment of the present invention. In certain embodiments of the present invention, a user creates, modifies, executes or operates a computer program described in this present invention exclusively with physical manipulatives.

Although the embodiments of the present invention describe systems and methods for creating a User Program using physical cards, it will be understood by those skilled in the art that physical cards can be replaced by any type of physical manipulatives embedded with machine-readable and unique identifications.

Although the embodiments of the present invention describe systems and methods that use RFID technology for the interactive board to read the UID of the physical sheet and physical cards, it will be understood by those skilled in the art that other machine-readable technologies may be used instead.

Before proceeding to describing the various embodiments of the present invention, proper definitions for key words and expressions will first be made.

A “Template Program” is a program generated by a vendor as a starting point for a programming user to further build up. A “user program” is defined as a program that the programming user creates by adding code into a Template Program. Both Template Programs and user programs are operated by operating users.

“User Programming Elements” are Object, Property, Method, or Event, defined in the same manner as they are commonly used in defining a programming language, and capitalized to distinguish them from their more “regular” usages. For example, a “method” claim versus a “Method” card—the former is not capitalized and is used in its “regular” meaning, while the latter is capitalized and is used as a User Programming Element. User Programming Element may be provided by a vendor. Further, a programming user is able to create or modify a portion of such programming elements to create a new User Programming Element. Other terms may be used to define the same concepts. For example, terms such as data, data fields, attributes, are also often used interchangeably with the term “Property”. The term “function” is often used instead of “Method”. It will be obvious to those are who are skilled in the art that the terms used should not be conceived as restrictive in any way and other terms also commonly used in the art may be used interchangeably.

“System Programming Elements” are defined as: control, operator and comparators with the programming user being able to utilize these programming elements but not able to alter the definition and usage of these programming elements. Control comprises of but is not limited to: delay, loop, loop forever, loop until, then, if then else, exit program. Operator comprises of but is not limited to: add, subtract, multiply, divide, exponent, set, color channel, build string, random integer, random float, square root, round, floor, ceiling, absolute, sign, minimum, maximum. Comparator comprises of but is not limited to: equal, not equal, less than, less than or equal, greater than, greater than or equal, and, or. A programming user cannot modify or create a new System Programming Element.

Within the present invention, User Programming Elements and System Programming Elements are individually or collectively referred to as programming element(s).

“System Services” are defined as a set of services that enable tangible human machine interactions. System Services comprise of but are not limited to: RFID reader, capacitance sensor, light, sound, microphone, and Speaker.

“User Content Elements” are defined as voices, music, text files, etc., and are generated by the programming user. User Content Elements are not provided by the vendor's Template Program but, rather, they originate from actions of a programming user as a way to enhance the expressions of the User Program. A user content card is therefore a card whose UID has been associated with a User Content Element.

“User Interface Elements” are defined as visual elements that are designed to capture the action of either a programming user or an operating user, or event elements such as the placement of a card on the interactive board, or features that allow the operating user to directly interact with the User Program during operation.

“Programming User Interface” is defined, in one embodiment of the present invention, as a physical sheet with a unique ID embedded that is recognized by an interactive board, and serves the purpose of providing a user interface for a programming user to create a user program. According to another embodiment of the present invention, the interactive board is equipped with a touch screen and a Programming Physical Sheet is replaced with a Programming User Interface, serving the same purpose, and the action of placing a Programming Physical Sheet on an interactive board is replaced with the action of starting the Programming User Interface on the screen of the interactive board.

“Operating User Interface” is defined, according to one embodiment of the present invention, as a physical sheet with a unique ID embedded that is recognized by an interactive board, and serves the purpose of providing a user interface for an operating user to operate a user program. According to one embodiment of the present invention, the interactive board is equipped with a touch screen and a Operating Physical Sheet is replaced with an Operating User Interface, serving the same purpose, and the action of placing an Operating Physical Sheet on an interactive board is replaced with the action of starting the Operating User Interface on the screen of the interactive board.

The various embodiments of the following invention describe a story-telling game that utilizes forest animals as a theme for a programming user to develop an interactive storyline and that the operating user interacts with the game using physical cards, touch, voice & sounds, as well as lights. It will be understood by one of ordinary skill in the art that these embodiments are presented for illustrative purposes only and that the present invention may be practiced using other potential program designs.

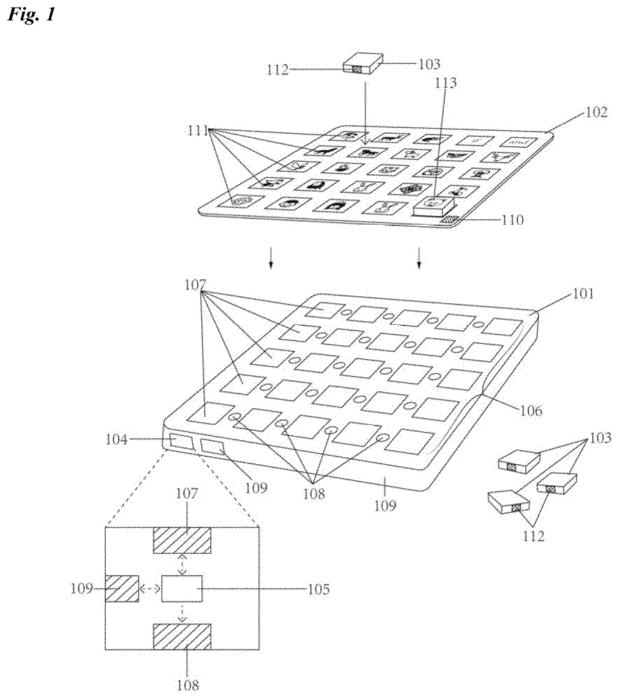

Finally, although the embodiments described in FIG. 1 through FIG. 9 utilize an interactive board and various physical sheets, alternative embodiments of the present invention may be described, whereby the interactive board and the various physical sheets are implemented as a touch screen device, and whereby each physical sheet is replaced by a user interface on the touch screen. It will be understood by one of ordinary skill in the art that these figures and embodiments are presented as a screen-less implementation for illustrative purposes only, that the present invention may be practiced using a touch screen device. In accordance with these other embodiments of the present invention, there is no need for a UID for the physical sheets, and the action of placing a physical sheet on an interactive board is replaced with starting a user interface on a screen of the interactive board.

The present invention may be better understood and its numerous objects and advantages will become apparent to those skilled in the art by reference to the accompanying drawings.

FIG. 1 is an exemplary schematic diagram illustrating a system for creating a User Program with programming cards using an interactive board, a programming physical sheet or a programming user interface, and multiple cards in accordance with one embodiment of the present invention.

As shown in FIG. 1, the system includes an interactive board 101, a first programming physical sheet 102 and blank cards 103. The interactive board 101 is embedded with or operatively connected to a computer system 104 having a processor 105. The interactive board 101 further includes a sensor array 106 upon its surface that is operatively connected to the computer system 104. The sensor array 106 is configured to detect the location of any tagged physical manipulative placed on or near the surface of the interactive board 101 as well as finger touches from a user made directly upon the sensor array 106 or indirectly upon any tagged object already placed upon the sensor array 106. A tagged object is any physical manipulative having an RFID tag containing a unique identification number (thereafter referred as UID).

The interactive board 101 further includes multiple RF antennas 107 that are operatively connected to the processor 105 and that are configured, whenever instructed by the processor 105, to read the UID of any tagged object located upon the interactive board 101's surface via wireless communication between the RF antennas 107 and the object's RFID tag.

The interactive board 101 further has an array of multicolored LED lights 108 embedded within its surface that are operatively connected to the computer system 104's processor 105.

The interactive board 101 further has an audio system 109 consisting of a speaker and a microphone that is operatively linked to the computer system 104's processor 105.

The first programming physical sheet 102 has an RFID tag 110 containing the physical sheet 102's UID. The first programming physical sheet 102 further has a library of icons printed on the sheet, with each icon representing a programming element 111. Programming elements 111 can be provided by either the vendor or the programming user.

Each blank card 103 further has an RFID tag 112 containing the card 103's UID.

The method of the embodiment illustrated in FIG. 1 is the following. The programming user firstly instructs the interactive board 101 to initiate a new Template Program after placing the first programming physical sheet 102 upon the interactive board 101. Subsequently, the computer system 104's processor 105 identifies the UID of the first programming physical sheet 102's RFID tag 110 wirelessly via the RF antennas 107 and loads the corresponding “Programming Element Association” application for the first programming physical sheet 102.

The programming user thereafter creates a programming card by first placing a blank card 103 on the first programming physical sheet 102 and then marking this blank card 103 with the icon of a desired programming element 111. Marking can consist of either drawing directly or applying a sticker on the blank card 103. In FIG. 1, the programming user has marked one blank card 113 by drawing a “Bear”.

The programming user thereafter associates the marked card 113 with the desired User Programming Element 111. Association of the marked card 113 is done whenever the programming user places the marked card 113 on top of the desired User Programming Element icon 111 printed on top of the first programming physical sheet 102 causing the computer system 104 of the interactive board 101 to associate and save the UID of the marked card 113 with the desired UID programming element 111. Any marked card 113 that has been associated with a User Programming Element is referred to as a user programming card.

In accordance with one embodiment of the present invention, the programming physical sheet 102 described in the proceeding paragraphs is replaced by a programming user interface 102. The interactive board 101 is equipped with a touch screen, and the programming user interface 102 is displayed in the screen.

According to this embodiment of the present invention and as shown in FIG. 1, the system includes an interactive board 101, a first programming user interface 102 displayed in the screen of the interactive board 101, and blank cards 103. The interactive board 101 is embedded with or operatively connected to a computer system 104 having a processor 105. The interactive board 101 further includes a sensor array 106 upon its surface that is operatively connected to the computer system 104. The sensor array 106 is configured to detect the location of any tagged physical manipulative placed on or near the surface of the interactive board 101 as well as finger touches from a user made directly upon the sensor array 106 or indirectly upon any tagged object already placed upon the sensor array 106. A tagged object is any physical manipulative having an RFID tag containing a unique identification number (thereafter referred as UID).

The interactive board 101 further includes one or multiple RF antennas 107 that are operatively connected to the processor 105 and that are configured, whenever instructed by the processor 105, to read the UID of any tagged object located upon the interactive board 101's surface via wireless communication between the RF antennas 107 and the object's RFID tag.

The interactive board 101 further has an audio system 109 consisting of a speaker and a microphone that is operatively linked to the computer system 104's processor 105.

The first programming user interface 102 has a library of icons displayed, with each icon representing a programming element 111. Programming elements 111 can be provided by either the vendor or the programming user.

Each blank card 103 further has an RFID tag 112 containing the card 103's UID.

The method of the embodiment illustrated in FIG. 1 is the following. The programming user firstly instructs the interactive board 101 to initiate a new Template Program after starting the first programming user interface 102 on the interactive board 101. Subsequently, the computer system 104's processor 105 loads the corresponding “Programming Element Association” application for the first programming user interface 102.

The programming user thereafter creates a programming card by first placing a blank card 103 on the first programming user interface 102 and then marking this blank card 103 with the icon of a desired programming element 111. Marking can consist of either drawing directly or applying a sticker on the blank card 103. In FIG. 1, the programming user has marked one blank card 113 by drawing a “Bear”.

The programming user thereafter associates the marked card 113 with the desired User Programming Element 111. Association of the marked card 113 is done whenever the programming user places the marked card 113 on top of the desired User Programming Element icon 111 displayed on top of the first programming user interface 102 causing the computer system 104 of the interactive board 101 to associate and save the UID of the marked card 113 with the desired UID programming element 111. Any marked card 113 that has been associated with a User Programming Element is referred to as a user programming card.

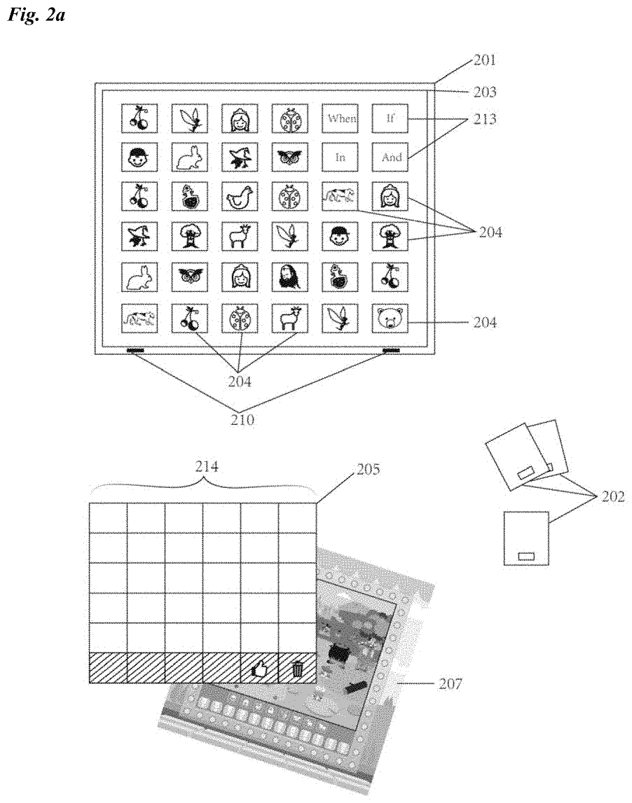

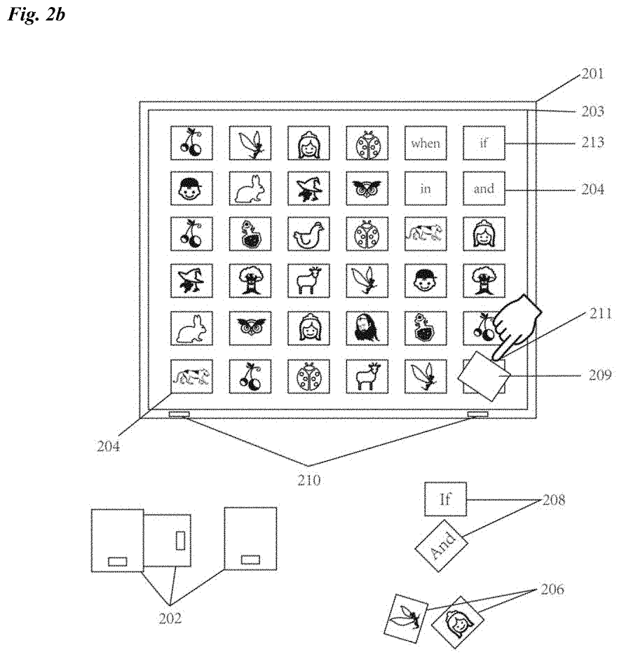

As self-evident in the descriptions regarding FIG. 1, the use of a physical sheet as the user interface in some embodiments, and the use of a user interface on a screen in some other embodiments, all serve the purpose of providing a programming user or an operating user with a user interface to carry out processes described in the present invention. In FIG. 2 through FIG. 9, we have selected “physical sheet” as an exemplary embodiment to describe the present invention.

FIGS. 2a and 2b are exemplary schematic diagrams illustrating the utilization of programming cards in a story-telling game that utilizes forest animals as a theme for a programming user to develop an interactive storyline in accordance with one embodiment of the present invention. A programming user can modify or create new content based on a Template Program to develop and enhance an interactive storyline that allows an operating user to interact with the game using cards, touch, voice & sounds, as well as lights.

Similar to the embodiment described in FIG. 1, the system includes an interactive board 201 that reads the UIDs of blank cards 202 or physical sheets placed on the interactive board 201, blank cards 202 each embedded with a UID, an operating physical sheet 207 embedded with a UID, and programming physical sheets, each embedded with a UID. The first programming physical sheet 203 is further imprinted with several icons, with each icon representing a programming element 204. The second programming physical sheet 205's surface is further imprinted with an array of squares 214 that serve as the programming cards' placement areas whenever the programming user generates a programming structure.

The programming elements 204 imprinted on the first programming physical sheet 203 include Objects, Methods, Properties, and Events that are related to a Template Program for a forest-based story-telling type game as well as various System Programming Elements. As illustrated in FIGS. 2a and 2b, some potential Objects associable to blank cards 202 are forest animals such as rabbit and bear. Some potential properties associable to blank cards 202 are name, speed, large. Some potential Methods associable to blank cards 202 are Come Out of Home, Run, Pursue, and Climb the Tree. Finally, some potential events associable to blank cards 202 are Sunny Day, Rainy Day. Programming elements can be provided by the vendor through the Template Program or created by the programming user using the programming physical sheets 203, 205 by creating a programming structure in order to generate a User Program.

In FIG. 2b, the programming user is utilizing two types of cards, user programming cards 206 and system programming cards 208, to generate a User Program. User programming cards 206 and system programming cards 208 are individually or collectively referred to as programming card(s).

FIG. 2b illustrates how the programming user associates a blank card 202 with one of the Object icons imprinted on the first programming physical sheet 203. As with FIG. 1, the programming user firstly instructs the interactive board 201 to initiate a new Template Program after placing the first programming physical sheet 203 upon the interactive board 201. The programming user thereafter can freely associate blank cards 202 with programming elements by placing the blank card 202 upon any of the programming element icons 204 imprinted on the first programming physical sheet 203 and confirming the selection after the interactive board 201's prompt.

In the embodiment illustrated in FIG. 2b, the programming user has associated a card 209 with the “Bear” User Programming Element. The interactive board 201 confirms the card 209's association with the “Bear” User Programming Element via the audio system's speaker 210 by playing an audio file back to the programming user. Confirmation is achieved after the programming user uses a finger touch 211 upon the card 209. Once the card 209's association is confirmed, the computer systems of the interactive board 201 saves the UID of that card 209 as the Object “Bear”. The programming user can mark card 209 with “Bear-related” indicia prior to or after its association.

In FIG. 2b, the programming user has also created a system programming card 208 by marking another card with the System Programming Element “If” and subsequently associated the card with the corresponding “If” icon 213 imprinted on the first programming sheet 203.

Once the programming user has created their desired programming cards 206, 208, they can proceed to create a programming structure upon the interactive board 201 using multiple programming cards 206, 208. A programming structure is formed once multiple programming cards are placed in a specific order upon a second programming physical sheet in a manner that a computer system can derive new programming code or the modification of existing programming code from the Template Program code or User Program code.

In order to create a programming structure, the programming user must firstly remove the first physical programming sheet 203 from the interactive board 201 and place the second programming physical sheet 205 instead. Once the UID of the second physical sheet 205 has been read by the interactive board 201's computer system, the processor loads the “Programming” mode application.

The programming user can then freely place programming cards 206, 208 on top of the specific squares the square array 214 with the sequence of the programming structure read from top to bottom and from left to right.

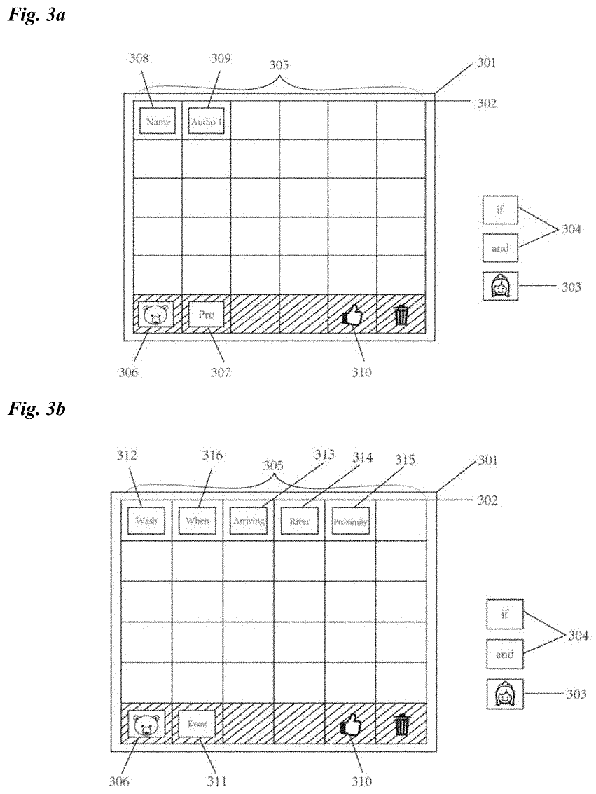

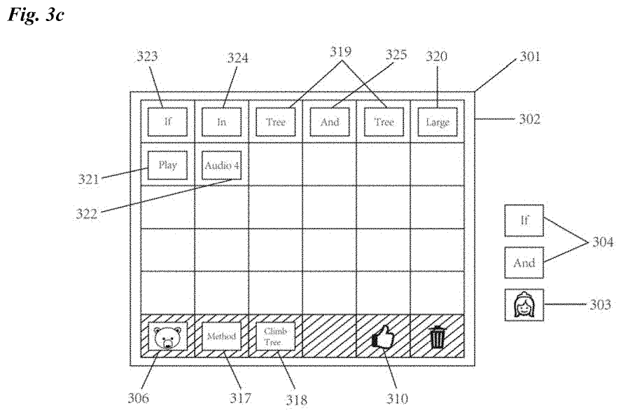

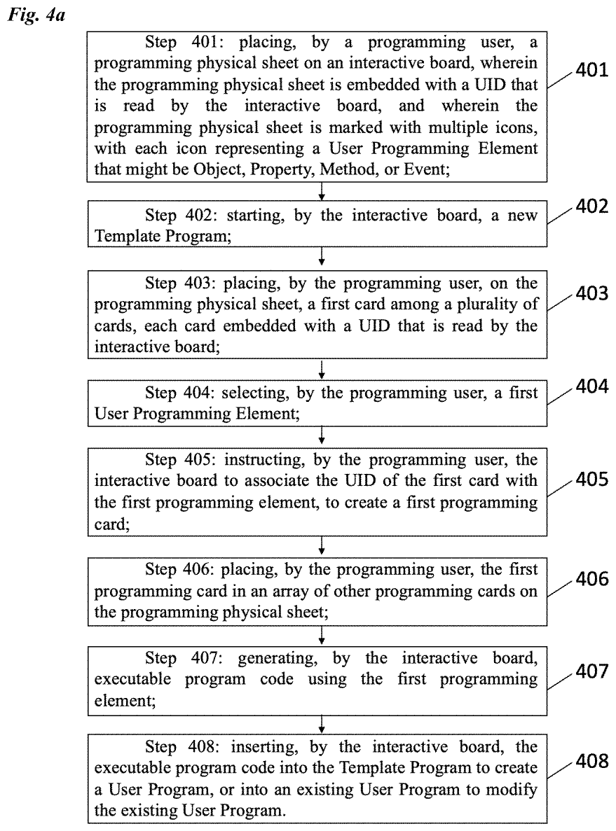

FIGS. 3a, 3b and 3c are exemplary schematic diagram illustrating the programming user making use of programming cards upon a second programming physical sheet to modify a Template Program in accordance to one embodiment of the present invention.

FIGS. 3a, 3b and 3c illustrate the modification of a Template Program or a User Program by using multiple programming cards 303, 304 placed on the second programming physical sheet 302 that is itself placed on the interactive board 301.

In FIG. 3a, the programming user modifies a Template Program or a User Program by changing a Property of the Object “Bear” programming card 306. This is achieved by placing the “Bear” card 306 and a “Property” type user programming card 307 on the last row of the second programming physical sheet 302 indicating to the computer system that the programming user is looking to add or modify a Property for the Object “Bear” from the Template Program code.

Adding or modifying the template code is referred to as the incorporation of a programming element into the template code. The programming element is used to generate executable program code, which is then inserted into the template code to create the User Program (or into an existing User Program to modify the existing user program). Executable program code is generated by placing multiple programming cards 303, 304 on the array of squares 305 of the second programming physical sheet 302. In FIG. 3a, the programming user has placed the programming card “Name” 308 on the second programming physical sheet 302's first row and the “Audio 1” card 309 on card 308's right-hand side, forming a programming structure, indicating to the computer system that the Property “Name” of the Object “Bear” will become the audio file corresponding to the “Audio 1” card 309. Executable program code is generated using the programming elements associated with the programming cards 308 and 309, and then inserted into the Template Program code to create a User Program. The programming user confirms the Object “Bear” Property modification by pressing on the “Confirm & Save” icon (depicted as a thumb up icon) 310 located on the bottom right-hand side of the second programming physical sheet 302. Once the Object's Property modification has been confirmed by the programming user, the audio file corresponding to the programming card “Audio 1” 309 will play whenever the “Name” Property is required during the user program's execution which is loaded whenever the operating user places an operating physical sheet upon the interactive board 301.

In FIG. 3b, the programming user modifies the Template Program by changing an Event of the Object “Bear” programming card 306 using both user programming and system programming cards 303, 304. Similar to the embodiment described in FIG. 3a, the programming user firstly places the “Bear” card 306 and an “Event” user programming card 311 upon the bottom row of the programming physical sheet 302 indicating to the computer system that the programming user is looking to add or modify an Event for the Object “Bear” from the Template Program code.

In FIG. 3b, the programming user has placed the user programming cards “Wash” 312, “Arriving” 313, “River” 314, and “Proximity” 315 as well as the system programming card “When” 316 on the first row of the second programming physical sheet 302. This programming structure indicates to the computer system that the Event “Wash” for the Object “Bear” will occur whenever the Object “Bear” is placed by the operating user in proximity of a river area of the operating physical sheet during the user program's execution. Similarly, executable program code is generated using the programming elements associated with the programming cards 312-316, and then inserted into the Template Program code to create a User Program. As before, the programming user confirms the modification by pressing on the “Confirm & Save” icon 310 located on the bottom right-hand side of the second programming physical sheet 302.

In FIG. 3c, the programming user is modifying the Template Program by changing a Method of the Object “Bear” programming card 306 using both user programming and system programming cards 303, 304. Similar to the embodiment described in FIGS. 3a and 3b, the programming user firstly places the “Bear” card 306, a “Method” user programming card 317, and a “Climb Tree” user programming card 318 on the last row of the second programming physical sheet 302 indicating to the computer system that the programming user is looking to add or modify a Method for the Object “Bear” from the Template Program code.

In FIG. 3c, the programming user has also placed the user programming cards “Tree” 319, “Large” 320, “Play” 321, and “Audio 4” 322 as well as the system programming cards “If” 323, “In” 324, and “And” 325 on the second programming physical sheet 302's first and second rows. This programming structure indicates to the computer system that the Method “Climb Tree” will occur for the Object “Bear” whenever the Object “Bear” is in a “Tree” area and that the tree is large. Similarly, executable program code is generated using the programming elements associated with the programming cards 319-325, and then inserted into the Template Program code to create a User Program. Furthermore, the computer system shall also broadcast the audio file corresponding to the card “Audio 4” 322 whenever that Method occurs during the user program's execution. As before, the programming user confirms the modification by pressing on the “Confirm & Save” icon 310 located on the bottom right-hand side of the second programming physical sheet 302.

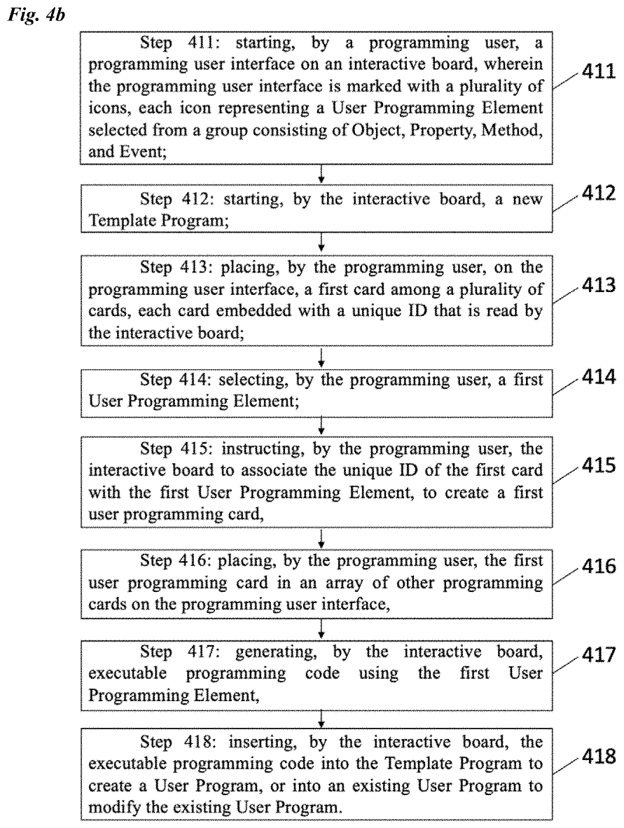

FIG. 4a and FIG. 4b. are exemplary schematic diagrams illustrating the process flow in accordance to embodiments of the present invention.

According to one embodiment of the present invention, the process flow for the present invention has the following steps:

Step 401: placing, by a programming user, a programming physical sheet on an interactive board, wherein the programming physical sheet is embedded with a UID that is read by the interactive board, and wherein the programming physical sheet is marked with multiple icons, with each icon representing a User Programming Element that might be Object, Property, Method, or Event;

Step 402: starting, by the interactive board, a new Template Program;

Step 403: placing, by the programming user, on the programming physical sheet, a first card among a plurality of cards, each card embedded with a UID that is read by the interactive board;

Step 404: selecting, by the programming user, a first User Programming Element;

Step 405: instructing, by the programming user, the interactive board to associate the UID of the first card with the first programming element, to create a first programming card;

Step 406: placing, by the programming user, the first programming card in an array of other programming cards on the programming physical sheet;

Step 407: generating, by the interactive board, executable program code using the first programming element;

Step 408: inserting, by the interactive board, the executable program code into the Template Program to create a User Program, or into an existing User Program to modify the existing User Program.

According to one embodiment of the present invention, the process flow for the present invention has the following steps:

Step 411: starting, by a programming user, a programming user interface on an interactive board, wherein the programming user interface is marked with a plurality of icons, each icon representing a User Programming Element selected from a group consisting of Object, Property, Method, and Event;

Step 412: starting, by the interactive board, a new Template Program;

Step 413: placing, by the programming user, on the programming user interface, a first card among a plurality of cards, each card embedded with a unique ID that is read by the interactive board;

Step 414: selecting, by the programming user, a first User Programming Element;

Step 415: instructing, by the programming user, the interactive board to associate the unique ID of the first card with the first User Programming Element, to create a first user programming card,

Step 416: placing, by the programming user, the first user programming card in an array of other programming cards on the programming user interface,

Step 417: generating, by the interactive board, executable programming code using the first User Programming Element,

Step 418: inserting, by the interactive board, the executable programming code into the Template Program to create a User Program, or into an existing User Program to modify the existing User Program.

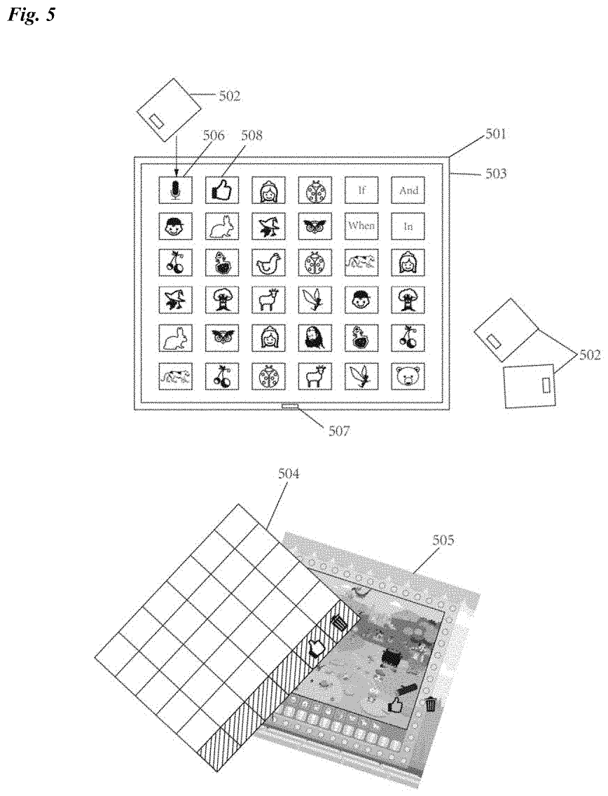

The programming user may also choose to create his/her own content to assign to a physical manipulative instead of selecting a programming element from a first programming physical sheet's library. FIG. 5 illustrates a blank card being associated with a programming user's recorded audio content in accordance with one embodiment of the present invention.

As with previous embodiments described herein, the system depicted in FIG. 5 includes an interactive board 501, multiple blank cards 502, each embedded with a UID, a first and a second programming physical sheets 503, 504, both embedded with UIDs, and an operating physical sheet 505 that is also embedded with a UID.

In FIG. 5, the programming user has firstly instructed the interactive board 501 to initiate a new Template Program after placing the first programming physical sheet 503 upon the interactive board 501. Subsequently, the interactive board 501 loads the corresponding “Programming Element Association” application for the first programming physical sheet 503. The programming user then places a blank card 502 upon the “Record Audio” icon 506 in order to start recording and save his/her speech and have said speech associated to the card 502. Typically, the computer system of the interactive board 501 will notify the programming user that the microphone 507 is recording the audio input. Once the programming user is satisfied with the recording, he/she will stop the recording by pressing on the “Confirm & Save” icon 508. Once the card 502 is associated with the recorded audio file, the programming user may incorporate that created content into a User Program whenever the second programming physical sheet 504 is placed upon the interactive board 501. As in previously described embodiments, the programming user can mark the blank card 502 with indicia related to the recorded audio file prior or after the blank card 502's association with the recorded content.

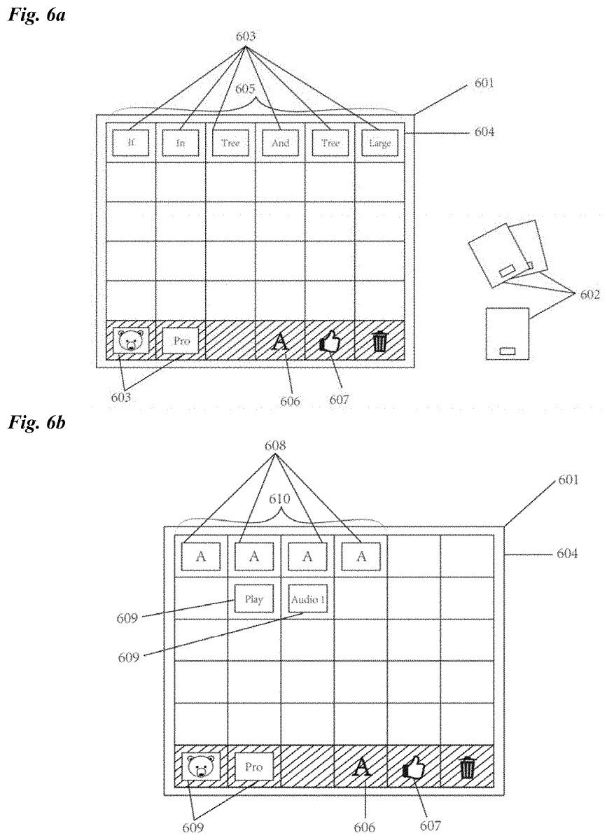

Once the programming user has created a programming structure on the second programming physical sheet, he/she can save said programming structure by making use of “Application Cards”. FIGS. 6a and 6b illustrate the use of application cards in accordance with one embodiment of the present invention.

The system depicted in FIG. 6a includes an interactive board 601, multiple blank cards 602, each embedded with a UID, marked cards 603 that have been associated to various programming elements, each embedded with a UID, and a second programming physical sheet 604 that is embedded with a UID.

In FIG. 6a, the programming user has created a desired programming structure 605 using multiple marked cards 603 placed upon the second programming physical sheet 604. As a result, a User Program is created based on the programming structure, incorporating the programming elements of the marked cards 603. The programming user thereafter saves and associates the User Program with a blank card 602 by placing the blank card 602 upon the “Application Card” icon 606 and thereafter pressing on the “Confirm & Save” icon 607. As with previously described embodiments, the programming user can mark the application card with indicia related to the saved programming structure 605.

FIG. 6b further depicts an instance in which the programming user has used multiple application cards 608 combined with multiple programming cards 609 in order to create a more complex programming structure 610. Once the application cards 608 are placed on the interactive board 601, the user programs associated with them are launched by interactive board 601.

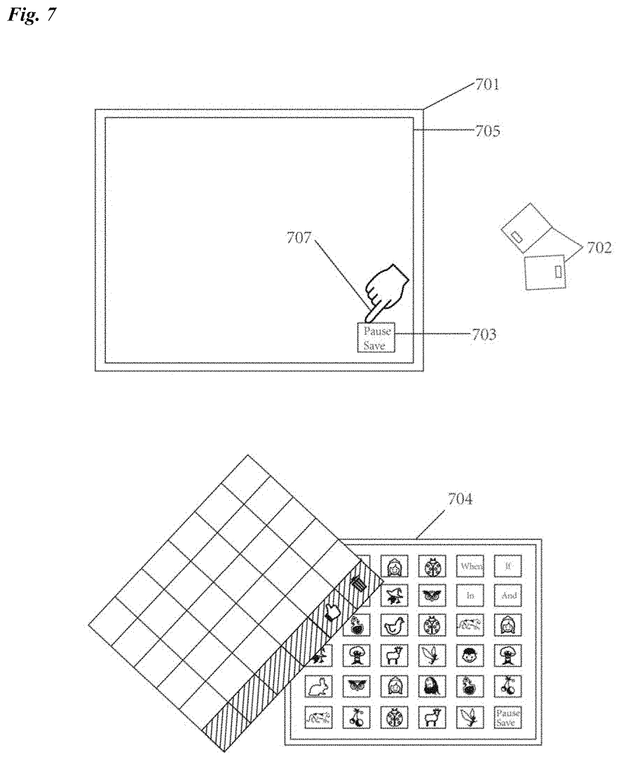

Additional functions can be added by the programming user for the operating user to navigate the system during the user program's execution. Specifically, the programming user can choose to associate various User Interface Elements to blank cards for use by the operating user during the execution of the program code. FIG. 7 is an exemplary schematic diagram illustrating the programming user creating a user interface card in accordance to one embodiment of the present invention.

The system depicted in FIG. 7 includes an interactive board 701, multiple blank cards 702, each embedded with a UID, a user interface card 703 that has been associated to a User Interface Element and that is further embedded with a UID, a first programming physical sheet 704 that is embedded with a UID, and an operating physical sheet 705 that is also embedded with a UID.

In the embodiment illustrated in FIG. 7, the programming user has associated a blank card 702 with the “Pause/Save” user interface icon printed on the first programming physical sheet 704 once the blank card 702 is placed on the first programming physical sheet 704. The programming user thereafter has marked this newly created user interface card 703 with the words “Pause & Save”.

The user interface card 703 is assigned two separate functions during the user program's execution. The “Pause” function can be activated by the operating user by simply placing the user interface card 703 upon the operating physical sheet 705 during the user program's execution. Its effect is to temporarily stop the execution of the User Program. The “Save” function is activated by the operating user by finger pressing 707 upon the user interface card 703 once it has already been placed upon the operating physical sheet 705 during the user program's execution. Its effect is to enable the operating user to save any progress made in the User Program until the point of activation of the “Save” function.

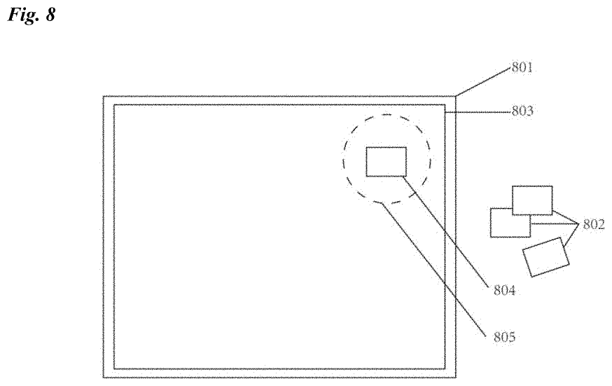

FIG. 8 is an exemplary schematic diagram illustrating the utilization of user interface cards to assign User Interface Elements on a blank operating physical sheet in accordance to one embodiment of the present invention.

The system depicted in FIG. 8 includes an interactive board 801, multiple user interface cards 802, each embedded with a UID and each associated with a User Interface Element, and a blank operating physical sheet 803 that is also embedded with a UID.

In the embodiment illustrated in FIG. 8, once the programming user has placed the blank operating physical sheet 803 upon the interactive board 801 and loaded the programming mode for that operating physical sheet 803, the programming user can freely associate different areas 805 of the operating physical sheet 803 with various programming elements as well as User Interface Elements. In the embodiment illustrated in FIG. 8, the programming user associates the “Pause & Save” user interface card 804 with an area 805 on the upper right-hand side of the blank operating physical sheet 803. Once the interactive board 801 confirms to the programming user that the association has been successfully achieved, the programming user thereafter marks the area 805 associated with the User Interface Element with the words “Pause & Save”. During the user program's operation, the operating user may interact with that area 805 by pressing upon on it to execute the “Pause & Save” function.

As the embodiment in FIG. 8 illustrates, a programming user can use multiple programming cards and user interface cards to associate various interactive elements on a blank operating sheet and marking them to create an interactive User Program.

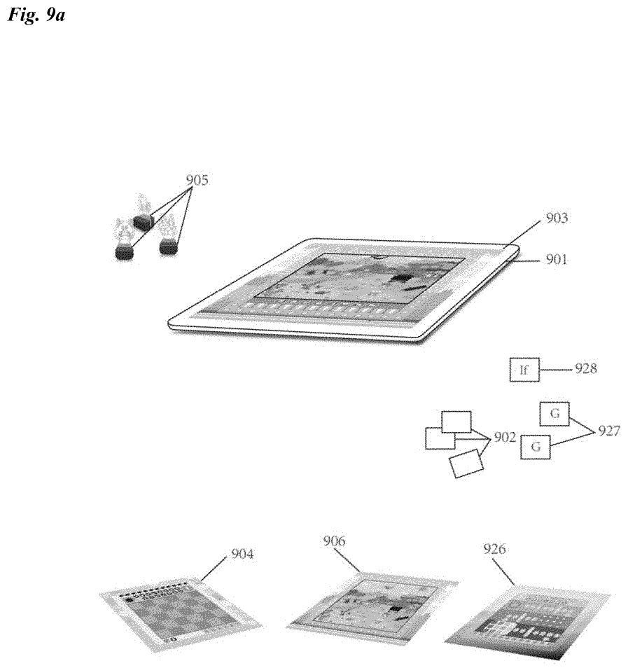

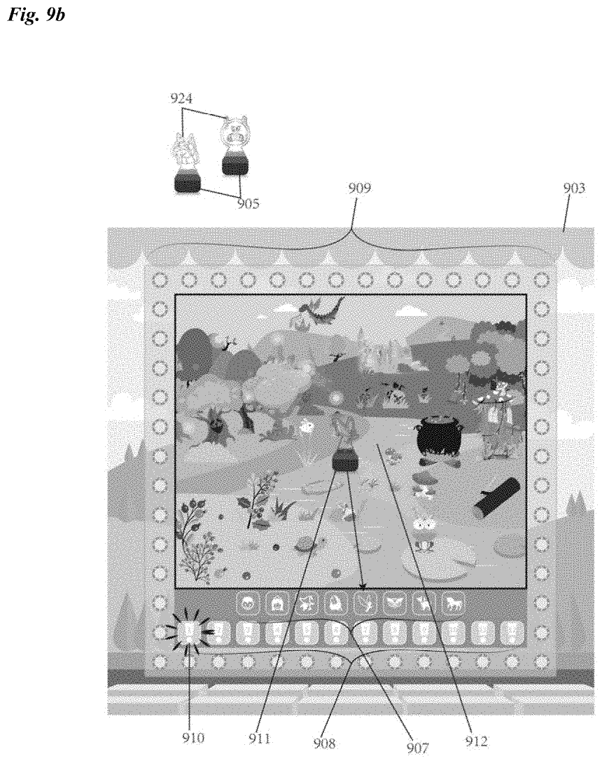

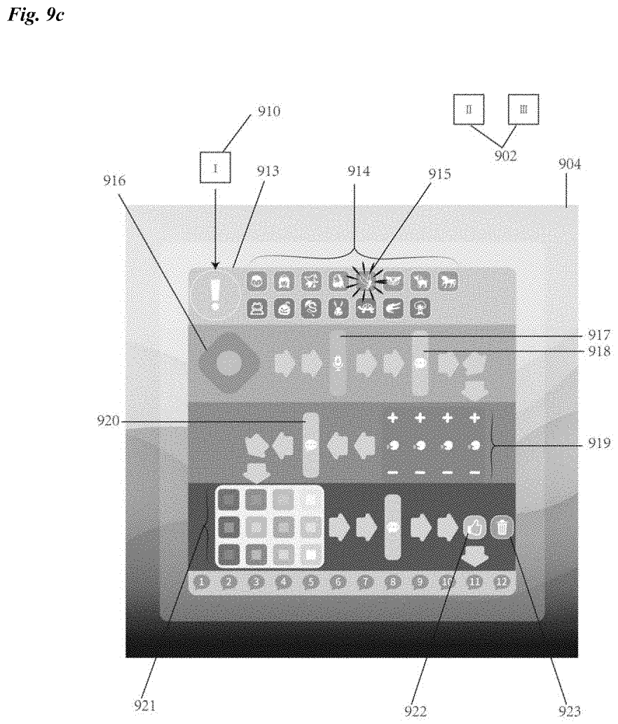

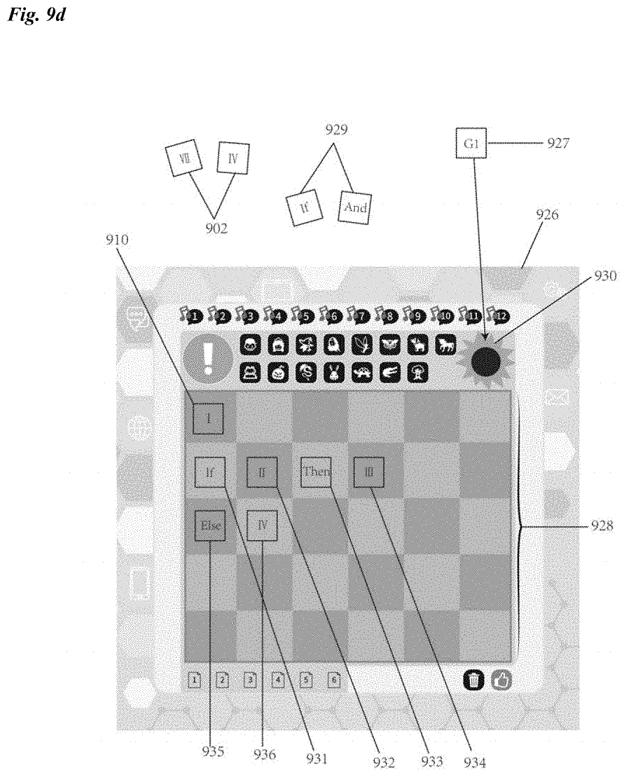

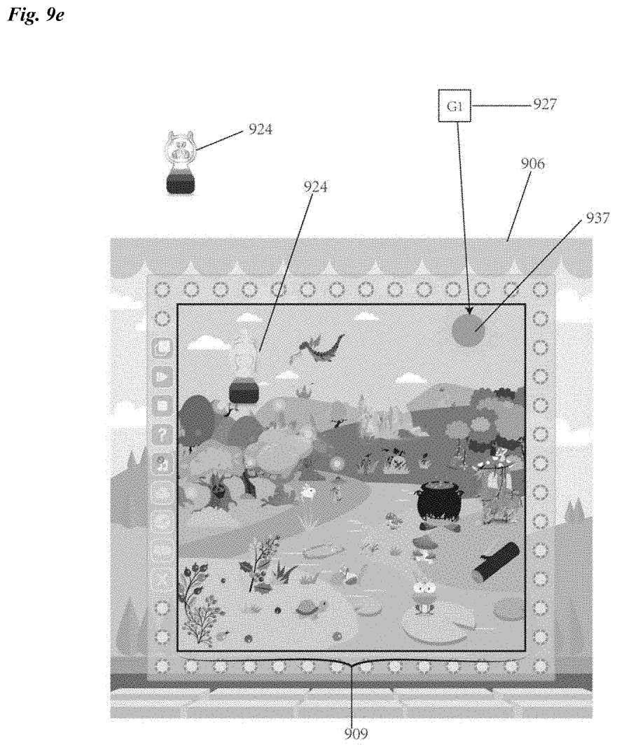

FIGS. 9a-9e are exemplary schematic diagrams illustrating the combination of multiple programming physical sheets, an operating physical sheet, and multiple cards and figurines upon an interactive board in order to create a story narration and action game in accordance with one embodiment of the present invention.

The embodiment illustrated in FIG. 9 shows that by combining the use of physical sheets, cards and figurines, a programming user can design a program that narrates a story through chapters that an operating User may interact with using multiple figurines and the icons illustrated across the scenery imprinted on the operating physical sheet.

The system depicted in FIG. 9a includes an interactive board 901, multiple Event cards 902, application cards 927, and system programming cards 928, each embedded with a UID, a first, second, and third programming physical sheets 903, 904, 926 that are embedded with UIDs, multiple figurine bases 905, embedded with UIDs, and an operating physical sheet 906 that is also embedded with a UID.

FIG. 9b illustrates the first step a programming user would take to design the storyline. The programming user would firstly place the first programming sheet 903 upon the interactive board 901 in order to launch the “figurine binding” mode. Once the computer program of the interactive board 901 initiates this mode, the programming user will be prompted to bind various story characters to figurine bases 905. This is achieved by having the programming user place a figurine base 905 upon the first programming physical sheet 903's character selection area 907. The interactive board 901 will prompt and confirm the character selection(s) using audio and LED feedback. Once confirmed, the computer system of the interactive board 901 will save the UID of the figurine base 905 with that of the selected character. Similar to previous embodiments, the programming user may choose to mark the associated figurine base 905 prior or after the binding. In the embodiment illustrated in FIG. 9b, marking a figurine base 905 consists of placing on top of the figurine base 905 a figurine 924 depicted the associated character.

Once all the characters a programming user desires to use in their storyline have been associated with a corresponding figurine base 905, the programming user then proceeds to associate character driven Events for the successive Events of the story. The programming user first selects the Event they desire to add or modify by pressing on an Event number of the Event table 908 located on the first programming physical sheet 903. As before, the interactive board 901 will prompt and confirm the Event selection(s) using audio and LED feedback. The programming user can then proceed to place one or more associated figurine bases 905 upon the story's scenery 909 in order to associate the figurine's character with a specific Event (an Event being whenever a character is located in an area of the scenery 909).

In the example illustrated in FIG. 9b, the programming user has first selected the Event 1 card 910 and subsequently placed the “Fairy” figurine 911 upon the river 912 depicted in the scenery 909 creating the “Fairy arrives at River” event for Event 1 of the storyline. As previously, the interactive board 901 will prompt and confirm the Event selection(s) using audio and LED feedback.

After the programming user has selected the desired characters and their corresponding Events on the first programming physical sheet 903, he/she may add more detailed content to the storyline via the second programming physical sheet 904 depicted in FIG. 9c.

In order to proceed, the programming user first removes the first programming physical sheet 903 and then places the second programming physical sheet 904 upon the interactive board 901. As previously described, the computer system of the interactive board 901 will identify the UID of the second programming physical sheet 904 and load the corresponding “event design” program assigned to it.

The programming user must first place an Event card 902 and place it on the Event area 913 located on the top left hand-side of the second programming physical sheet 904 in order to add or modify content for that specific Event of the storyline. Once the Event card 902 is placed on the Event area 913, the interactive board 901 will confirm the Event selection using audio and LED feedback. Furthermore, the interactive board 901's computer system would instruct to light up the LEDs located behind the character icons located on the character bar 914 whose character were previously associated with the selected Event.

In FIG. 9c, the programming user has placed the Event 1 card 910 upon the Event area 913 and the LED located behind the character icon for “Fairy” 915 is lit up notifying to the programming user that this character is associated with Event 1 and content related to the “Fairy” character can be further added or modified.

After the programming user has indicated which Event they wish to add or modify content to, they proceed to place the figurine base associated to the character they desire to add or modify content to upon the character area 916. Such an action would cause the interactive board 901's computer system to identify the UID of the figurine base and infer what character the programming user has selected. As before, the character selection will be confirmed by the interactive board 901 using audio and LED feedback.

After selecting the character, the programming user can proceed to create User Content Elements, by recording the desired speech for that character by pressing and holding on the first microphone icon 917, causing the computer system to have the microphone of the interactive board 901 to start recording. The programming user can then recite the dialog they wish to associate the character with and stop the recording by removing their finger from the icon 917. The recording can be reheard whenever the programming user presses on the “Broadcast Audio” icon 918 located besides the first microphone icon 917. Once the recording is finished, the computer system will save the recorded audio file and associate it with the selected Event in the storyline.

The programming user can also modify the style of the audio recording by selecting a particular style and further modifying the recording sound pitch on the “Audio Adjustment” area 919. Modifications of the recorded audio can be further reheard whenever the programming user presses on the “Broadcast Audio 2” icon 920 located besides the ‘Audio adjustment’ area 919.

After the audio file associated to the character has been saved, the programming user can also add LED effects that can be played at the same time as the audio file broadcast. This is achieved by selecting any of the predesigned LED visual effects from the “Visual Effect” menu 921.

Once the programming user has completed the character content addition or modification for the selected Event, they can either confirm the content by pressing the “Confirm” icon 922 or reject it by pressing the “Delete” icon 923. In the case that the programming user confirms the content, the saved content is assigned a number on the “Saved Event” bar located at the bottom of the second interactive physical sheet 904.

After the programming user has finished adding or modifying content for one or more Events using the second programming physical sheet 904, they may create conditional storylines that an operating user can pick from by creating programming structures by using the third programming physical sheet 926 depicted in FIG. 9d.

As before, in order to proceed, the programming user must first remove the second programming physical sheet 904 and then places the third programming physical sheet 926 upon the interactive board 901. The computer system of the interactive board 901 will then identify the UID of the third programming physical sheet 926 and load the corresponding “programming structure generation” program assigned to it.

The programming user must first place a application card 927 and place it on the application card area 930 located on the top right hand-side of the third programming physical sheet 926 in order to associate and save any generated programming structure created on the programming structure matrix 928 with the application card 927.

Any programming structure can thereafter be generated by the programming user by placing and combining Event cards 902 and system programming cards 929 upon the programming structure matrix 928. In the example illustrated in FIG. 9d, the programming user has placed the Event 1 card 910 on the first row of the of the programming structure matrix 928 indicating that the storyline begins whenever the operating user initiates the action associated with Event 1 (e.g., Fairy arrives at River' event). The programming user has also placed the system programming card “If” 931 on the first square of the second row of the programming matrix 928 and further placed the Event 2 card 932, the “Then” system programming card 933, and finally the Event 3 card 934. This programming structure signifies that whenever Event 2 occurs, Event 3 will subsequently occur. On the third row of the programming structure matrix 928, the programming user has also placed the “Else” system programming card 935 and further placed the Event 4 card 936 on its right hand-side signifying that, during game operation, if Event 2 does not occur, Event 4 shall occur.

Once the programming user has completed all the desired programming structure generation, they can press on the “thumbs up” icon located on the bottom right hand-side of the third programming physical sheet 926 to save all generated programming structures and associate these with the application card 927 placed on the application card area 930.

After the programming user has finished adding or modifying content for the storyline, the game can be played via the operating physical sheet 906 depicted in FIG. 9e.

In order to initiate the game designed by the programming user, the operating user must firstly place the operating physical sheet 906 upon the interactive board 901. As previously described, the computer system of the interactive board 901 will identify the UID of the operating physical sheet 906. Thereafter, the programming user can place any application card 927 that has been associated with added or modified content on the Load Storyline area 937 located in the top right hand-side of the operating physical sheet 906. This action will cause the interactive board 901 to load the corresponding storyline associated with that application card 927.

Once the storyline content is loaded, the operating user may interact freely with the operating physical sheet 906 by placing figurines 924 upon various areas of the scenery 909. The operating user will follow the storyline designed by the programming user by carefully paying attention to the audio and visual feedback and making decisions as to what actions they may need to take thereafter.

It should be noted that an Event such as the “Fairy arrives at River” event has been created by a programming user, and therefore is a new User Programming Element that has not existed prior to the programming work of the programming user.

1. A system for creating a User Program with programming cards, comprising
a plurality of cards, each embedded with a unique ID,
a programming user interface, marked with a plurality of icons, each icon representing a User Programming Element selected from a group consisting of Object, Property, Method, and Event,
an interactive board that reads the unique ID of a card, upon the card being placed on the interactive board,
wherein, a programming user starts the programming user interface on the interactive board, and instructs the interactive board to start a new Template Program, and
wherein, the programming user creates a first user programming card, by placing a first card on the programming user interface, by selecting a first User Programming Element, and by instructing the interactive board to associate the unique ID of the first card with the first User Programming Element, and
wherein, the interactive board is configured to incorporate the User Programming Element into a User Program, by generating executable program code using the first User Programming Element, and by inserting the executable program code into the Template Program to create the User Program, or into an existing User Program to modify the existing User Program, upon the programming user placing the first user programming card in an array of other programming cards on the programming user interface to create a programming structure.

2. The system of claim 1, further comprising a system programming card,
wherein, the programming user creates the system programming card by instructing the interactive board to associate the unique ID of a card among the plurality of cards with a System Programming Element, and
wherein, the System Programming Element is selected by the programming user from a group consisting of control, operator and comparator, and
wherein, the interactive board is configured to incorporate the System Programming Element into the User Program, upon the programming user placing the system programming card in an array of other programming cards on the programming user interface.

3. The system of claim 1, further comprising System Services,
wherein, a System Service is provided by a device selected from a group consisting of light, sound, capacitance sensor, RFID reader, microphone, and speaker,
wherein, the device is operatively linked to the interactive board, and
wherein, the interactive board is configured to enable the programming user to call upon the System Service using a programming card.

4. The system of claim 1, further comprising a user content card,
wherein, the programming user creates the user content card by instructing the interactive board to associate the unique ID of a card among the plurality of cards with a User Content Element, and
wherein, the User Content Element is provided by the programming user, and
wherein, the interactive board is configured to enable the programming user to incorporate the User Content Element into the User Program.

5. The system of claim 1, further comprising an application card,
wherein, the programming user instructs the interactive board to associate the User Program or a segment of the User Program with the application card, and
wherein, the interactive board is configured to launch the User Program or a segment of the User Program, upon the application card having been placed on the interactive board.

6. The system of claim 5, further comprising an operating user interface marked with the user interface of the User Program, wherein an operating user operates the User Program upon the application card having been placed on the operating user interface.

7. The system of claim 1, wherein the interactive board is configured to associate the unique ID of a second card with more than one programming elements selected by the programming user.

8. The system in claim 1, wherein the programming user modifies a card to create a visual indication of the programming element having been or to be associated with the card.

9. A system for incorporating a User Content Element into a User Program, comprising
a card, embedded with a unique ID,
a User Content Element provided by a programming user,
an interactive board that reads the unique ID of a card,
wherein, the programming user creates a user content card by instructing the interactive board to associate the unique ID of the card with the User Content Element, and
wherein, the interactive board is configured to incorporate the User Content Element into a User Program, upon the programming user placing the user content card on the interactive board.

10. A system for creating a user programming card, comprising
a plurality of cards, each card embedded with a unique ID,
a plurality of User Programming Elements, each selected from a group consisting of Object, Property, Method, and Event,
an interactive board that reads the unique ID of a card, upon the card being placed on the interactive board,
wherein, a programming user creates a first user programming card, by instructing the interactive board to associate the unique ID of a first card selected by the programming user with a first User Programming Element selected by the programming user, and
wherein, the interactive board is configured to generate executable program code using the first User Programming Element, upon the programming user placing the first user programming card in an array of other programming cards on the interactive board.

11. The system of claim 10, further comprising a new User Programming Element created by the programming user, wherein, the programming user modifies a card among the plurality of cards to create a visual indication of the new User Programming Element, and instructs the interactive board to associate the unique ID of the card with the new User Programming Element.

12. The system of claim 10, wherein, the interactive board is configured to generate a new User Programming Element, upon a programming user placing or moving a card among the plurality of cards on the interactive board.

13. A system for creating user interface of a User Program with user interface cards, comprising
a plurality of user interface cards, each user interface card embedded with a unique ID and associated with a User Interface Element,
an operating user interface,
an interactive board that reads the unique ID of the user interface cards upon the user interface cards being placed on the interactive board,
wherein, a programming user places a first user interface card on the operating user interface, and draws an icon of the first User Interface Element on the operating user interface, and
wherein, the interactive board is configured to associate the icon with the first User Interface Element, and to incorporate the first User Interface Element into a User Program.

14. The system of claim 13, further comprising
a plurality of cards, each card embedded with a unique ID, and
a programming user interface, marked with a plurality of icons, with each icon representing a User Interface Element,
wherein, a programming user selects the icon of a first User Interface Element,
wherein, the programming user creates the first user interface card, by instructing the interactive board to associate the unique ID of a first card selected by the programming user with the first User Interface Element, upon the first card being placed on the programming user interface.

15. A method for creating a User Program with programming cards, comprising
starting, by a programming user, a programming user interface on an interactive board,
wherein the programming user interface is marked with a plurality of icons, each icon representing a User Programming Element selected from a group consisting of Object, Property, Method, and Event;
starting, by the interactive board, a new Template Program;
placing, by the programming user, on the programming user interface, a first card among a plurality of cards, each card embedded with a unique ID that is read by the interactive board;
selecting, by the programming user, a first User Programming Element;
instructing, by the programming user, the interactive board to associate the unique ID of the first card with the first User Programming Element, to create a first user programming card;
placing, by the programming user, the first user programming card in an array of other programming cards on the programming user interface;
generating, by the interactive board, executable programming code using the first User Programming Element;
inserting, by the interactive board, the executable programming code into the Template Program to create a User Program, or into an existing User Program to modify the existing User Program.

16. The method of claim 15, further comprising
creating, by the programming user, a system programming card, by instructing the interactive board to associate the unique ID of a card among the plurality of cards with a System Programming Element, wherein, the System Programming Element is selected by the programming user from a group comprising control, operator and comparator, and
placing, by the programming user, the system programming card in an array of other programming cards on the programming user interface, and
incorporating, by the interactive board, the System Programming Element into the User Program.

17. The method of claim 15, further comprising
providing a System Service by a device selected from a group consisting of light, sound, capacitance sensor, RFID reader, microphone, and speaker, wherein the device is operatively linked to the interactive board,
enabling, by the interactive board, the programming user to call upon the System Service using a programming card.

18. The method of claim 15, further comprising
creating, by the programming user, a user content card by instructing the interactive board to associate the unique ID of a card among the plurality of cards with a User Content Element, wherein the User Content Element is provided by the programming user,
enabling, by the interactive board, the programming user to incorporate the User Content Element into the User Program.

19. The method of claim 15, further comprising
instructing, by the programming user, the interactive board to associate the User Program or a segment of the User Program with an application card, and
launching, by the interactive board, the User Program or a segment of the User Program upon the application card having been placed on the interactive board.

20. The method of claim 19, further comprising
operating, by an operating user, the User Program upon the application card having been placed on an operating user interface, wherein the operating user interface is marked with the user interface of the User Program.

21. The method of claim 15, further comprising
associating, by the interactive board, the unique ID of a second card with more than one programming elements selected by the programming user.

22. The method of claim 15, further comprising
modifying, by the programming user, a card to create a visual indication of the programming element having been or to be associated with the card.

23. A method for incorporating a User Content Element into a User Program, comprising
providing, by a programming user, a User Content Element,
associating, by an interactive board, the unique ID of a card with the User Content Element to create a user content card, wherein, the card is embedded with a unique ID that is read by the interactive board,
incorporating, by the interactive board, the User Content Element into a User Program upon the user content card having been placed on the interactive board.

24. A method for creating a user programming card, comprising
selecting, by a programming user, a first card among a plurality of cards, each card embedded with a unique ID,
selecting, by the programming user, a first User Programming Element among a group of User Programming Elements consisting of Object, Property, Method, and Event,
associating, by an interactive board, the unique ID of the first card with the first User Programming Element to create a first user programming card,
placing, by the programming user, the first user programming card in an array of other programming cards on the interactive board,
generating, by the interactive board, executable program code using the first User Programming Element.

25. The method of claim 24, further comprising
creating, by the programming user, a new User Programming Element,
modifying, by the programming user, a card among the plurality of cards to create a visual indication of the new User Programming Element, and
associating, by the interactive board, the unique ID of the card with the new User Programming Element.

26. The method of claim 24, further comprising
generating a new User Programming Element by placing or moving a card among the plurality of cards on the interactive board.

27. A method for creating the user interface of a User Program with user interface cards, comprising
starting, by a programming user, on an interactive board, an operating user interface,
placing, by the programming user, on the operating user interface, a first user interface card selected from a plurality of user interface cards, each user interface card embedded with a unique ID and associated with a User Interface Element,
drawing, by the programming user, an icon of the first User Interface Element on the operating user interface,
associating, by the interactive board, the icon with the first User Interface Element,
incorporating, by the interactive board, the first User Interface Element into a User Program.

28. The method of claim 27, further comprising
selecting, by the programming user, a first card among a plurality of cards, each card embedded with a unique ID,
placing, by the programming user, the first card on a programming user interface marked with a plurality of icons, with each icon representing a User Interface Element,
selecting, by the programming user, the icon of a first User Interface Element,
creating, by the programming user, a first user interface card, by instructing the interactive board to associate the unique ID of the first card with the first User Interface Element.
